(19) United States
(12) Patent Application Publication
(10) Pub. No.: US 2025/0158234 A1
(43) Pub. Date: May 15, 2025

(54) ELECTRODE ASSEMBLY, ELECTROCHEMICAL DEVICE, AND ELECTRONIC DEVICE

(71) Applicant: Ningde Amperex Technology Limited, Ningde (CN)

(72) Inventors: Fudong JIN, Ningde (CN); Hua WU, Ningde (CN)

(73) Assignee: Ningde Amperex Technology Limited, Ningde (CN)

(21) Appl. No.: 18/945,970

(22) Filed: Nov. 13, 2024

(30) Foreign Application Priority Data
Nov. 14, 2023 (CN) 202311509057.X

(51) Int. Cl. H01M 50/477; H01M 50/474

(52) U.S. Cl. CPC H01M 50/477; H01M 50/474

(57) ABSTRACT

An electrode assembly includes a first electrode plate, a first tab, and a first insulation piece. The first electrode plate includes a first current collector and a first active material layer that disposed on a surface of the first current collector. A part of the surface of the first current collector exposes the first active material layer to form a first groove. one end of the first tab is disposed in the first groove, and is electrically connected to the first current collector. The first insulation piece includes a first portion and a protruding portion. The first portion is fixed onto the first active material layer. The first portion covers the first groove. The protruding portion covers the first tab. Along a length direction of the first electrode plate, a width of the protruding portion is less than or equal to a width of the first groove.

### CROSS-REFERENCE TO RELATED APPLICATION

This application claims priority to Chinese Patent Application No. 202311509057.X, filed on Nov. 14, 2023, the disclosure of which is hereby incorporated by reference in its entirety.

### TECHNICAL FIELD

This application relates to the field of battery technology, and in particular, to an electrode assembly, an electrochemical device, and an electronic device.

### BACKGROUND

Lithium-ion batteries are widely used in the field of consumer electronics by virtue of many advantages such as high volumetric and gravimetric energy densities. However, with the advancement of technology, electrical devices are imposing higher requirements on the energy density of the lithium-ion batteries. How to optimize the structure of electrode assembly and further increase the energy density of the electrode assembly has become an urgent technical challenge.

### SUMMARY

This application provides an electrode assembly, an electrochemical device, and an electronic device to meet the above challenge.

Some embodiments of this application are implemented in the following way:

An electrode assembly is disclosed, where the electrode assembly includes a first electrode plate, a first tab, and a first insulation piece. The first electrode plate includes a first current collector and a first active material layer. The first active material layer is disposed on a surface of the first current collector. A part of the surface of the first current collector exposes the first active material layer to form a first groove. One end of the first tab is disposed in the first groove. Another end of the first tab extends along a width direction of the first electrode plate. The first tab is electrically connected to the first current collector. The first insulation piece includes a first portion and a protruding portion. The first portion covers the first groove. The protruding portion extends toward the first current collector. The first portion is fixed onto the first active material layer. The protruding portion covers the first tab. Along a length direction of the first electrode plate, a width of the protruding portion is less than or equal to a width of the first groove. The first portion and the protruding portion provide double-layer isolation protection for the tab, and avoid the need to affix insulation adhesive corresponding to the first groove onto the electrode plate opposite to the first electrode plate, thereby reducing the area of the insulation adhesive, reducing the coverage area of the insulation piece on the active material layer on the electrode plate, and increasing the energy density of the electrode assembly.

In the above embodiment, along the thickness direction of the first electrode plate, the sum of the thickness of the protruding portion, the thickness of the first tab, and the thickness of the first current collector is less than or equal to the thickness of the first electrode plate. In this way, the protruding portion is embedded in the first electrode plate, thereby reducing the protruding height of the first insulation piece at the first groove. On the one hand, this is conducive to reducing the thickness of the electrode assembly and increasing the energy density. On the other hand, this can improve the consistency of the surface of the electrode plate and improve the cycle performance of the electrode assembly.

In one or more of the above embodiments, along a thickness direction of the first electrode plate, a sum of a thickness of the protruding portion and a thickness of the first tab is less than or equal to a thickness of the first active material layer, thereby reducing the extent by which the protruding portion protrudes beyond the first active material layer, reducing the thickness of the electrode assembly, and increasing the energy density.

In one or more of the above embodiments, the electrode assembly further includes a separator. The separator is disposed on at least one side of the first electrode plate along a thickness direction of the first electrode plate. The first portion is fixed and connected to the separator, thereby alleviating displacement of the first insulation piece in the electrode assembly, and further improving the safety performance of the electrode assembly.

In one or more of the above embodiments, the first portion includes hot-melt adhesive. The first portion is bonded to the separator.

In one or more of the above embodiments, an adhesive layer is disposed on one side of the protruding portion, the side is oriented toward the first tab, and the adhesive layer is bonded to the first tab. In this way, the protruding portion keeps fixed to the tab, the first tab can be disposed synchronously with the protruding portion in the first groove, thereby simplifying the manufacturing process and avoiding the displacement of the protruding portion, where the displacement causes exposure of the metal structure in the first groove.

In one or more of the above embodiments, an adhesive layer is disposed on one side of the protruding portion, the side is oriented toward the first portion, and the adhesive layer is bonded to the first portion. In this way, the protruding portion keeps fixed to the first portion, and the protruding portion and the first portion can be connected into one. The protruding portion and the first portion are disposed at the first groove in the same process, thereby improving manufacturing efficiency.

In one or more of the above embodiments, an adhesive layer is disposed on one side of the first portion, the side is oriented toward the protruding portion, and the adhesive layer is bonded to the protruding portion, thereby fixing the protruding portion to the first portion.

In one or more of the above embodiments, the first electrode plate is a positive electrode plate.

In one or more of the above embodiments, the electrode assembly further includes a second insulation piece. The second insulation piece is disposed on a surface of the first active material layer. The second insulation piece is spaced apart from the first groove along a length direction of the first electrode plate.

In one or more of the above embodiments, the electrode assembly further includes a second electrode plate and a second tab. The second electrode plate and the first electrode plate are stacked. The second electrode plate includes a second current collector and a second active material layer. The second active material layer is disposed on a surface of the second current collector. A part of the second current collector exposes the second active material layer to form a second groove. A projection of the second insulation piece on the surface of the second active material layer covers the second groove. One end of the second tab is disposed in the second groove, and another end of the second tab extends along a width direction of the second electrode plate. The second tab is electrically connected to the second current collector. The second insulation piece is configured to isolate the second tab to prevent the burrs on the second tab from contacting the first electrode plate and causing an internal short circuit of the electrode assembly.

In one or more of the above embodiments, the electrode assembly further includes a third insulation piece. The third insulation piece is disposed on the second electrode plate. The third insulation piece covers the second current collector and the second tab in the second groove, so as to isolate the metal structure in the second groove.

In one or more of the above embodiments, along a length direction of the first electrode plate, a difference between a width of the first portion and a width of the first groove is 1 mm to 4 mm. By constraining the dimensional relationship between the first portion and the first groove, the first portion can fully cover the first groove and adhere to the first active material layer while maintaining the existing manufacturing accuracy, and alleviate the adverse effect on the energy density.

In one or more of the above embodiments, along a length direction of the first electrode plate, a difference between a width of the first groove and a width of the protruding portion is 0 mm to 4 mm, so that the protruding portion can be accommodated in the first groove while covering and shielding the metal structure in the first groove as much as possible.

In a possible embodiment, along a length direction of the first electrode plate, a difference between a width of the protruding portion and a width of the first tab is 0 mm to 5 mm, thereby reducing the risk that the tab structure in the groove is exposed outside the protruding portion due to process errors.

In one or more of the above embodiments, the first active material layer is disposed on surfaces of the first current collector on two opposite sides of the first current collector. The first groove is created on the first active material layers on both surfaces on the two opposite sides of the first current collector. The two first grooves are disposed correspondingly. The first tab is disposed in one of the first grooves. The groove structure created on both sides can reduce the difficulty of welding the tab to the first current collector. There are two first portions. The two first portions cover two first grooves respectively to prevent the burrs being exposed from the other groove.

In one or more of the above embodiments, along a width direction of the first electrode plate, a lateral edge of the protruding portion protrudes beyond a lateral edge of the first groove to prevent the metal structure in the first groove from being exposed due to manufacturing process errors, and enhance the safety performance. In one or more of the above embodiments, along a thickness direction of the first electrode plate, the electrode assembly satisfies: 2a+b≤c+80 μm, where a thickness of the protruding portion is a, a thickness of the first tab is b, and a thickness of the first electrode plate is c. The protruding portion may be partially embedded or not embedded in the first electrode plate. The energy density is increased by controlling the thickness of the first electrode plate, the thickness of the tab, and the thickness of the protruding portion to fall within an appropriate range.

An embodiment of this application further provides an electrochemical device. The electrochemical device includes a packaging shell and the electrode assembly disclosed in the above embodiment. The electrode assembly is disposed in the packaging shell.

An embodiment of this application further provides an electronic device.

The electronic device includes an electrical component and the electrochemical device disclosed in the above embodiment. The electrical component is electrically connected to the electrochemical device.

### BRIEF DESCRIPTION OF DRAWINGS

To describe technical solutions in embodiments of this application more clearly, the following outlines the drawings to be used in the embodiments. Understandably, the following drawings show merely some embodiments of this application, and therefore, are not intended to limit the scope. A person of ordinary skill in the art may derive other related drawings from the drawings without making any creative efforts.

FIG. 1 is a schematic structural diagram of an electrode assembly according to an embodiment of this application;

FIG. 2 is a schematic structural diagram of an electrode assembly according to another embodiment;

FIG. 3 is a schematic structural diagram of an electrode assembly according to another embodiment;

FIG. 4 is a schematic structural diagram of a first tab in the electrode assembly shown in FIG. 3;

FIG. 5 is a schematic structural diagram of an electrochemical device according to an embodiment; and

FIG. 6 is a schematic structural diagram of an electronic device according to an embodiment.

### LIST OF REFERENCE NUMERALS

electrode assembly 100
first electrode plate 10
first current collector 11
first active material layer 12
first groove 13
first tab 20
first insulation piece 30
first portion 31
protruding portion 32
second insulation piece 40
second electrode plate 50
second current collector 51
second active material layer 52
second groove 53
second tab 60
third insulation piece 70
separator 80
electrochemical device 200
packaging shell 201
electronic device 300
electrical component 301

This application is further described below with reference to the following specific embodiments and the foregoing drawings.

### DETAILED DESCRIPTION

The following clearly and thoroughly describes the technical solutions in some embodiments of this application with reference to the drawings hereto. Evidently, the described embodiments are merely a part of but not all of the embodiments of this application.

It is hereby noted that a component referred to as being “fixed to” another component may be directly fixed onto the other component or may be fixed onto the other component through an intermediate component. A component considered to be “connected to” another component may be directly connected to the other component or may be connected to the other component through an intermediate component. A component considered to be “disposed on” another component may be directly disposed on the other component or may be disposed on the other component through an intermediate component. The terms “vertical”, “horizontal”, “left”, “right” and similar expressions used herein are merely for ease of description.

Unless otherwise defined, all technical and scientific terms used herein bear the same meanings as what is normally understood by a person skilled in the technical field of this application. The terms used in the specification of this application are merely intended to describe specific embodiments but not to limit this application. The term “and/or” used herein is intended to include any and all combinations of one or more relevant items recited.

The following describes some embodiments of this application in detail. To the extent that no conflict occurs, the following embodiments and the features in the embodiments may be combined with each other.

Referring to FIG. 1, an embodiment of this application provides an electrode assembly 100. The electrode assembly includes a first electrode plate 10, a first tab 20, and a first insulation piece 30. The first electrode plate 10 includes a first current collector 11 and a first active material layer 12. The first active material layer 12 is disposed on a surface of the first current collector 11. A part of the surface of the first current collector 11 exposes the first active material layer 12 to form a first groove 13. The protruding portion 32 extends toward the first current collector 11 along a direction that is approximately perpendicular to the first portion 31. One end of the first tab 20 is disposed in the first groove 13. Another end of the first tab extends along a width direction of the first electrode plate 10. The first tab 20 is electrically connected to the first current collector 11. The perpendicularity with an error of +5° or less belongs to the perpendicularity defined herein. The first insulation piece 30 includes a first portion 31 and a protruding portion 32. The first portion 31 is fixed onto the first active material layer 12. The first portion 31 covers the first groove 13. The protruding portion 32 covers the first tab 20. The protruding portion 32 may be connected to or in contact with the first tab 20. Along the length direction of the first electrode plate 10, the width of the protruding portion 32 is less than or equal to the width of the first groove 13, so that the protruding portion 32 can be accommodated in the first groove 13. The first portion 31 and the protruding portion 32 provide double-layer isolation protection for the tab, and avoid the need to affix an insulation piece corresponding to the first groove 13 onto the electrode plate opposite to the first electrode plate 10, thereby reducing the coverage area of the insulation piece on the active material layer on the electrode plate, and increasing the energy density of the electrode assembly 100.

In one of the embodiments of this application, along a width direction of the first electrode plate 10, a lateral edge of the protruding portion 32 protrudes beyond a lateral edge of the first groove 13 to prevent the metal structure in the first groove 13 from being exposed due to manufacturing process errors, and enhance the safety performance.

In one embodiment of this application, along the width direction of the first electrode plate 10, the protruding portion 32 protrudes beyond the lateral edge of the first groove 13 on one side protruding toward the first tab 20. The other side of the protruding portion 32 may be disposed in the first groove 13, and may further abut against the bottom wall of the first groove 13. In this way, the protruding portion 32 can shield the metal structure in the first groove 13 as far as possible. The metal structure in the first groove 13 may be the first tab 20, the first current collector 11, or the like. In another embodiment, along the width direction of the first electrode plate 10, the two opposite sides of the protruding portion 32 may protrude beyond the two opposite sides of the first groove 13 respectively, so as to further reduce the risk of exposure of the metal structure in the first groove 13.

Along a direction perpendicular to the thickness direction of the first electrode plate 10, the sum of the thickness of the protruding portion 32, the thickness of the first tab 20, and the thickness of the first current collector 11 is less than or equal to the thickness of the first electrode plate 10. This can reduce the extent by which the first insulation piece 30 protrudes out at the first groove 13. On the one hand, this is conducive to reducing the thickness of the electrode assembly 100 and increasing the energy density. On the other hand, this can improve the consistency of the surface of the electrode plate and improve the cycle performance of the electrode assembly 100.

In one embodiment, along the thickness direction of the first electrode plate 10, the sum of the thickness of the protruding portion 32 and the thickness of the first tab 20 is less than or equal to the thickness of the first active material layer 12, thereby preventing the protruding portion 32 from protruding beyond the first active material layer 12, reducing the thickness of the battery cell, and increasing the energy density.

In one possible embodiment, along the thickness direction of the first electrode plate 10, the electrode assembly satisfies: 2a+b≤c+80 μm, where the thickness of the protruding portion 32 is a, the thickness of the first tab 20 is b, and the thickness of the first electrode plate 10 is c. The units of a, b, and c are all μm. The thickness c of the first electrode plate 10 includes the thickness of the first current collector 11 and the thickness of the first active material layer 12, in μm. The protruding portion 32 may be partially embedded or not embedded in the first electrode plate 10. The thickness of the electrode assembly is reduced and the energy density is increased by controlling the thickness of the first electrode plate 10, the thickness of the tab, and the thickness of the protruding portion 32 to fall within an appropriate range.

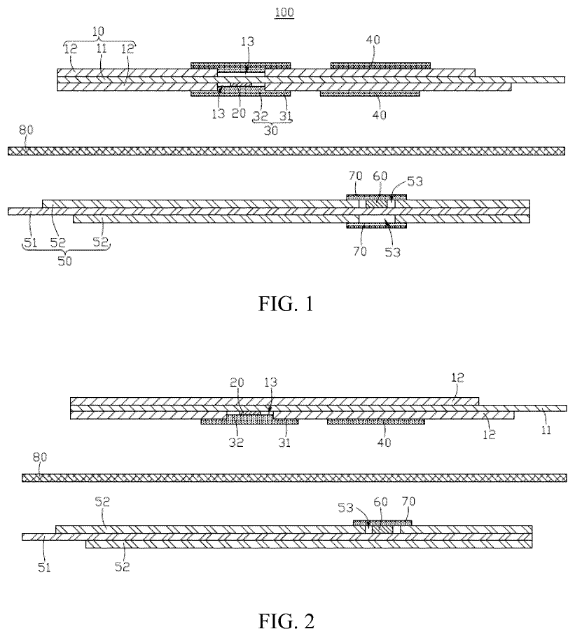

Specifically, in the embodiment shown in FIG. 2, the first active material layer 12 is applied on the surfaces of the first current collector 11 on the two opposite sides of the first current collector. A part of the surface on one side of the first current collector 11 exposes the first active material layer 12 to form a first groove 13. The sum of the thickness of the protruding portion 32, the thickness of the first tab 20, and the thickness of the first current collector 11 is less than or equal to the sum of the thickness of the first current collector 11 and the thickness of the active material layer on one side on which the first groove 13 is located. In this way, the protruding portion 32 is accommodated in the first groove 13, and the surface of the protruding portion 32 on one side oriented toward the first portion 31 is prevented from protruding beyond the surface of the first active material layer 12, thereby reducing the protruding height by which the first insulation piece 30 protrudes out at the first groove 13. On the one hand, this is conducive to reducing the thickness of the electrode assembly 100 and increasing the energy density. On the other hand, this can improve the consistency of the surface of the electrode plate and improve the cycle performance of the electrode assembly 100.

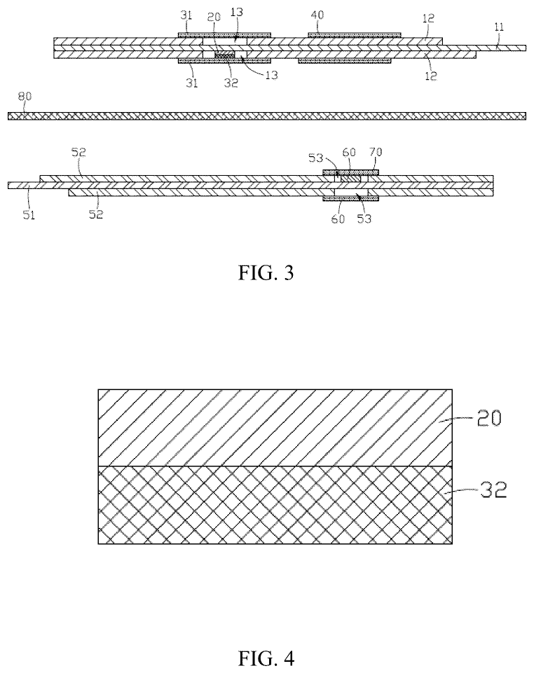

In some other embodiments, as shown in FIG. 1, the first active material layer 12 is applied on the surfaces of the first current collector 11 on two opposite sides of the first current collector. The first groove 13 is created on the first active material layers 12 on both surfaces on the two opposite sides of the first current collector 11. The two first grooves 13 are disposed correspondingly. The first tab 20 is disposed in one of the first grooves 13. The groove structure created on both sides can reduce the difficulty of welding the tab to the first current collector 11. There are two first insulation pieces 30. The two first insulation pieces 30 are disposed at the two first grooves 13 respectively to prevent the burrs on the tab from being exposed from the other groove. The protruding portion 32 in each first insulation piece 30 does not protrude beyond the surface of the first active material layer 12. Alternatively, as shown in FIG. 3, the number of the first portions 31 is two. The two first portions 31 cover the two first grooves 13 respectively. A protruding portion 32 is disposed in the first groove 13 on one side. The surface of the protruding portion 32 does not protrude beyond the surface of the first active material layer 12.

Still referring to FIG. 1, the electrode assembly 100 further includes a separator 80. The separator 80 is disposed on at least one side of the first electrode plate 10 along the thickness direction of the first electrode plate 10. The first portion 31 is fixed and connected to the separator 80, thereby alleviating displacement of the first insulation piece 30 in the electrode assembly 100, and further improving the safety performance of the electrode assembly 100.

In one embodiment, the first portion 31 includes hot-melt adhesive. The first portion 31 can be bonded to the separator 80 by hot-pressing, so as to fix the first portion 31 to the separator 80. When the first portion 31 is affixed to the first electrode plate 10, the separator 80 can keep fixed to the first electrode plate 10 through the first portion 31, thereby alleviating displacement of the first electrode plate 10 during charge-discharge cycles, and improving the electrical performance of the electrode assembly 100.

In a possible embodiment of this application, an adhesive layer is disposed on one side of the protruding portion 32, the side is oriented toward the first tab 20, and the adhesive layer is bonded to the first tab 20. In this way, the protruding portion 32 keeps fixed to the tab, the first tab 20 can be disposed synchronously with the protruding portion 32 in the first groove 13, thereby simplifying the manufacturing process and avoiding the displacement of the protruding portion 32, where the displacement causes exposure of the metal structure in the first groove 13.

Specifically, as shown in FIG. 3 and FIG. 4, the protruding portion 32 can be compounded onto the surface of the first tab 20, and the first tab 20 and the protruding portion 32 are connected into one. The compounding method includes, but is not limited to, adhesive layer bonding, hot-pressing, light curing, heat curing, and the like. When the first tab 20 is welded and connected to the first current collector 11 in the first groove 13, the protruding portion 32 is disposed together with the first tab 20 in the first groove 13, thereby simplifying the manufacturing steps and improving the production efficiency. In other embodiments, as shown in FIG. 1 and FIG. 2, the protruding portion 32 may be a single-sided adhesive tape. The adhesive layer is disposed on one side of the protruding portion 32, the side being oriented toward the first tab 20. When the protruding portion 32 is disposed at the first groove 13, the adhesive layer can be bonded to the surface of the first tab 20, so as to fix the protruding portion 32 to the first tab 20 and avoid displacement of the protruding portion 32, where the displacement causes exposure of the metal structure in the first groove 13.

In another embodiment, an adhesive layer is disposed on one side of the protruding portion 32, the side is oriented toward the first portion 31, and the adhesive layer is bonded to the first portion 31; and/or, an adhesive layer is disposed on one side of the first portion 31, the side is oriented toward the protruding portion 32, and the adhesive layer is bonded to the protruding portion 32. In this way, the protruding portion 32 keeps fixed to the first portion 31. The protruding portion 32 and the first portion 31 may be connected into one by the adhesive layer to form a hollow inverted-T structure. In the same manufacturing process, the protruding portion 32 and the first portion 31 are disposed at the first groove 13 simultaneously, the protruding portion 32 is accommodated in the first groove 13, and the first portion 31 covers the first groove 13, thereby improving the manufacturing efficiency.

Specifically, both the protruding portion 32 and the first portion 31 may be single-sided tape or double-sided tape. When both the protruding portion 32 and the first portion 31 are single-sided tape, the adhesive layers of the protruding portion and the first portion are disposed opposite to each other and bonded to each other. Before the first insulation piece 30 is affixed to the first electrode plate 10, the protruding portion 32 is bonded to the first portion 31 to form a hollow inverted-T structure first. When the first portion 31 is bonded to the first active material layer 12 to cover the first groove 13, the protruding portion 32 is embedded into the first groove 13 simultaneously. The side, oriented away from the first portion 31, of the protruding portion 32 may be spaced apart from or in contact with the surface of the first tab 20. Before the position of the first portion 31 is fixed, the protruding portion 32 may move relative to the first tab 20 to facilitate adjustment of the position at which the first insulation piece 30 is affixed, and improve the alignment accuracy. When the protruding portion 32 is double-sided tape and the first portion 31 is single-sided tape, after the protruding portion 32 is bonded to the first portion 31 to form a hollow inverted-T structure, the protruding portion 32 may be further bonded and fixed to the first tab 20 in the first groove 13, thereby increasing the bonding force between the first insulation piece 30 and the first electrode plate 10. When the protruding portion 32 is single-sided tape and the first portion 31 is double-sided tape, the hollow inverted-T structure formed by the protruding portion and the first portion can be bonded and fixed to both the first active material layer 12 and the separator 80 at the first groove 13 at the same time. When both the protruding portion 32 and the first portion 31 are double-sided tape, the hollow inverted-T structure formed by the protruding portion and the first portion can be bonded to the first tab 20, the first active material layer 12, and the separator 80 at the corresponding positions respectively, thereby improving the safety performance and electrical performance of the electrode assembly 100.

In an embodiment of this application, along the length direction of the electrode plate, the width of the first groove 13 is 8 mm to 15 mm, and the width of the first portion 31 is 10 mm to 20 mm. The width of the first portion 31 is greater than or equal to the width of the first groove 13, so that the first portion 31 can cover and shield the first groove 13. The width of the first tab 20 is 4 mm to 11 mm, and the width of the protruding portion 32 is 5 mm to 13 mm. The width of the protruding portion 32 is greater than or equal to the width of the first tab 20, so that the protruding portion 32 fully covers and shields the first tab 20.

Further, along the length direction of the first electrode plate 10, the difference between the width of the first portion 31 and the width of the first groove 13 is 1 mm to 4 mm. In an embodiment of this application, the difference between the width of the first portion 31 and the width of the first groove 13 may be 1 mm, 2 mm, 3 mm, 4 mm, or a value falling within a range formed by any two thereof. By constraining the dimensional relationship between the first portion 31 and the first groove 13, the first portion 31 can fully cover the first groove 13 while maintaining the existing manufacturing accuracy, and alleviate the adverse effect on the energy density.

Along the length direction of the first electrode plate 10, the difference between the width of the first groove 13 and the width of the protruding portion 32 is 0 mm to 4 mm, so that the protruding portion 32 can be accommodated in the first groove 13 while covering and shielding the metal structure in the first groove 13 as much as possible, thereby alleviating the exposure of the metal structure caused by fluctuation of the tolerance. In an embodiment of this application, the difference between the width of the first groove 13 and the width of the protruding portion 32 is 0 mm, 1 mm, 2 mm, 3 mm, 4 mm, or a value falling within a range formed by any two thereof.

Along the length direction of the first electrode plate 10, the difference between the width of the protruding portion 32 and the width of the first tab 20 is 0 mm to 5 mm, thereby reducing the risk that the tab structure in the groove is exposed outside the protruding portion 32 due to process errors. In an embodiment of this application, the difference between the width of the protruding portion 32 and the width of the first tab 20 is 0 mm, 1 mm, 2 mm, 3 mm, 4 mm, 5 mm, or a value falling within a range formed by any two thereof.

In a specific embodiment, as shown in FIG. 2, a blank foil region is disposed on a single side of the first electrode plate 10. In other words, the first groove 13 is disposed on the first active material layer 12 on a surface of the first current collector 11 on one side of the current collector. Along the length direction of the first electrode plate 10, the width of the first groove 13 is 9 mm, and the first tab 20 is welded onto the first current collector 11 in the first groove 13. The width of the first tab 20 is 5 mm. The protruding portion 32 and the first portion 31 form a first insulation piece 30 of a hollow inverted-T structure. The width of the first portion 31 is 11 mm, thereby ensuring that the first groove 13 can be covered in a case of tolerance fluctuation. The width of the protruding portion 32 is 7 mm. The protruding portion 32 is accommodated in the first groove 13, thereby ensuring that the first tab 20 can be covered in a case of tolerance fluctuation and isolated from the welding burrs on the first tab 20. The difference between the width of the first portion 31 and the width of the first groove 13 is 2 mm. The difference between the width of the first groove 13 and the width of the protruding portion 32 is 2 mm. The difference between the width of the protruding portion 32 and the width of the first tab 20 is 2 mm. In this embodiment, by disposing a first insulation piece 30 of a hollow inverted-T structure on the first electrode plate 10, the width difference between the first portion 31 and the first groove 13 is reduced while ensuring sufficient safety performance, thereby improving the utilization of the active materials, exerting the capacity of the battery more efficiently, and increasing the energy density.

In another embodiment, the protruding portion 32 may be disposed on one side of the first portion 31, the side being oriented away from the first tab 20. The projection of the protruding portion 32 in the first groove 13 covers the first tab 20. The protruding portion 32 is pressed into the first groove 13 from one side of the first portion 31, the side being oriented away from the first tab 20. In this way, a part of the first portion 31 is also accommodated in the first groove 13, thereby further reducing the thickness of the electrode assembly 100.

In another specific embodiment, as shown in FIG. 1, a double-side blank foil region is disposed on the first electrode plate 10. In other words, the first groove 13 is created on the first active material layers 12 on both surfaces on the two opposite sides of the first current collector 11, and the two first grooves 13 are disposed opposite to each other, so that the first current collector 11 at the first groove 13 is coated with the active material on neither side. Along the length direction of the first electrode plate 10, the width of the first groove 13 is 9 mm, and the first tab 20 is welded onto the first current collector 11 in the first groove 13. The width of the first tab 20 is 5 mm. The protruding portion 32 and the first portion 31 form a first insulation piece 30 of a hollow inverted-T structure. The two first insulation pieces 30 are disposed at the two first grooves 13 respectively. The width of the first portion 31 is 11 mm, thereby ensuring that the first groove 13 can be covered in a case of tolerance fluctuation. The width of the protruding portion 32 is 7 mm. The protruding portion 32 is accommodated in the first groove 13, thereby ensuring that the first tab 20 can be covered in a case of tolerance fluctuation and isolated from the welding burrs on the first tab 20. The difference between the width of the first portion 31 and the width of the first groove 13 is 2 mm. The difference between the width of the first groove 13 and the width of the protruding portion 32 is 2 mm. The difference between the width of the protruding portion 32 and the width of the first tab 20 is 2 mm.

In another specific embodiment, as shown in FIG. 3 and FIG. 4, a double-side blank foil region is disposed on the first electrode plate 10. In other words, the first groove 13 is created on the first active material layers 12 on both surfaces on the two opposite sides of the first current collector 11, and the two first grooves 13 are disposed opposite to each other, so that the first current collector 11 at the first groove 13 is coated with the active material on neither side. Along the length direction of the first electrode plate 10, the width of the first groove 13 is 9 mm, and the first tab 20 is welded onto the first current collector 11 in the first groove 13.

A layer of protruding portion 32 is disposed on the surface of the first tab 20 beforehand by means of thermal bonding, high-frequency bonding, or other means, so as to form a composite tab. The composite tab includes two parts: a metal layer and an insulation layer. The first tab 20 is the metal layer of the composite tab, and the protruding portion 32 is the insulation layer of the composite tab. The metal layer is 5 mm wide and 80 μm thick. The insulation layer is 5 mm wide and 16 μm thick. The first current collector 11 in the first groove 13 is connected to the metal layer of the composite tab by laser welding, riveting, or other means. The main material of the metal layer includes aluminum. The main material of the insulation layer includes polyethylene and/or polypropylene.

The two first portions 31 are disposed at the two first grooves 13 respectively. The width of the first portion 31 is 11 mm, thereby ensuring that the first groove 13 can be covered in a case of tolerance fluctuation. The difference between the width of the first portion 31 and the width of the first groove 13 is 2 mm. The difference between the width of the first groove 13 and the width of the protruding portion 32 is 2 mm. The difference between the width of the protruding portion 32 and the width of the first tab 20 is 0 mm.

Still referring to FIG. 1 to FIG. 3, in an embodiment of this application, the electrode assembly 100 further includes a second insulation piece 40. The second insulation piece 40 is disposed on a surface of the first active material layer 12. The second insulation piece 40 is spaced apart from the first groove 13 along the length direction of the first electrode plate 10. The second insulation piece 40 is configured to isolate the tab on the electrode plate opposite to the first electrode plate 10, thereby improving the safety performance of the electrode assembly 100. The electrode assembly 100 further includes a second insulation piece 40, a second electrode plate 50, and a second tab 60. The second electrode plate 50 and the first electrode plate 10 are stacked. The second electrode plate 50 includes a second current collector 51 and a second active material layer 52. The second active material layer 52 is disposed on a surface of the second current collector 51. A part of the surface of the second current collector 51 exposes the second active material layer 52 to form a second groove 53. The projection of the second insulation piece 40 on the surface of the second active material layer 52 covers the second groove 53. One end of the second tab 60 is disposed in the second groove 53, and another end of the second tab extends along the width direction of the second electrode plate 50. The second tab 60 is electrically connected to the second current collector 51. The second insulation piece 40 is configured to isolate the second tab 60 to prevent the burrs on the second tab 60 from contacting the first electrode plate 10 and causing an internal short circuit of the electrode assembly 100.

In the prior art, the first electrode plate 10 is a positive electrode plate, and the second electrode plate 50 is a negative electrode plate. After being disposed in the first groove 13, the first tab is protected by an insulation piece. An insulation piece is also disposed on the negative electrode plate corresponding to the first groove 13. To avoid lithium plating, the area of the insulation piece disposed on the first groove 13 needs to be larger than the area of the insulation piece on the negative electrode plate corresponding to the first groove 13. In an embodiment of this application, the first electrode plate 10 is a positive electrode plate, and the second electrode plate 50 is a negative electrode plate. Because the protruding portion 32 and the first portion 31 are disposed at the first groove 13 of the first electrode plate 10, no additional insulation adhesive needs to be affixed to a position corresponding to the first groove 13 on the second electrode plate 50, and a first portion of a relatively small area can be disposed, thereby improving exertion of the capacity of the first electrode plate. Further, more second active materials are utilized efficiently, the second electrode plate 50 can provide more lithiation sites, thereby alleviating lithium plating. Further, the electrode assembly 100 further includes a third insulation piece 70. The third insulation piece 70 is disposed on the second electrode plate 50. The third insulation piece 70 covers the second current collector 51 and the second tab 60 in the second groove 53, so as to isolate the metal structure in the second groove 53, and prevent the burrs on the second tab 60 from piecing the separator 80 and contacting the first tab 20 to cause a short circuit. In addition, the third insulation piece 70 can cover a part of the first active material layer 12, so that the area of the second active material layer 52 is larger than the area of the first active material layer 12, thereby alleviating lithium plating.

The third insulation piece 70 may be an insulation adhesive. Along the length direction of the second electrode plate 50, the width of the third insulation piece 70 may be greater than the width of the second groove 53, so that the third insulation piece 70 is affixed to the surface of the second active material layer 52 and covers the second groove 53 to prevent the metal structure in the second groove 53 from being exposed. In another embodiment, the width of the third insulation piece 70 may be less than or equal to the width of the second groove 53 instead, so that the third insulation piece 70 can be accommodated in the second groove 53 like the protruding portion 32, thereby reducing the thickness of the second electrode plate 50 and further increasing the energy density of the electrode assembly 100.

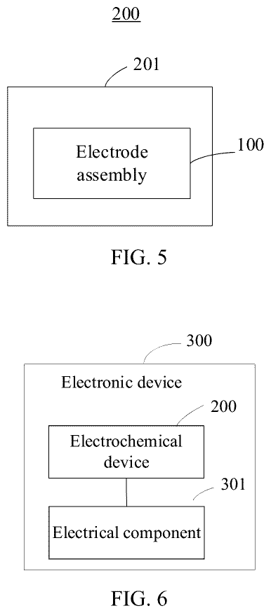

Referring to FIG. 5, an embodiment of this application further provides an electrochemical device 200. The electrochemical device includes a packaging shell 201 and the electrode assembly 100 disclosed in the above embodiment. The electrode assembly 100 is disposed in the packaging shell 201.

Referring to FIG. 6, an embodiment of this application further provides an electronic device 300. The electronic device includes an electrical component 301 and the electrochemical device 200 disclosed in the above embodiment. The electrical component 301 is electrically connected to the electrochemical device 200. The electrochemical device 200 is configured to provide electrical energy for the electrical component 301.

The foregoing embodiments are merely intended for describing the technical solutions of this application but not intended as a limitation. Although this application is described in detail with reference to the foregoing exemplary embodiments, a person of ordinary skill in the art understands that modifications or equivalent substitutions may be made to the technical solutions of this application without departing from the spirit and scope of the technical solutions of this application.

What is claimed is:

1. An electrode assembly, wherein the electrode assembly comprises:
a first electrode plate, comprising a first current collector and a first active material layer, wherein the first active material layer is disposed on a surface of the first current collector, and a part of the surface of the first current collector is exposed by forming a first groove on the first active material layer;
a first tab, wherein one end of the first tab is disposed in the first groove, and another end of the first tab extends along a width direction of the first electrode plate, and the first tab is electrically connected to the first current collector; and
a first insulation piece, wherein the first insulation piece comprises a first portion and a protruding portion, the first portion covers the first groove, the protruding portion extends from the first portion toward the first current collector, the first portion is fixed onto the first active material layer, the protruding portion covers the first tab, and, along a length direction of the first electrode plate, a width of the protruding portion is less than or equal to a width of the first groove.

2. The electrode assembly according to claim 1, wherein, along a thickness direction of the first electrode plate, a sum of a thickness of the protruding portion, a thickness of the first tab, and a thickness of the first current collector is less than or equal to a thickness of the first electrode plate.

3. The electrode assembly according to claim 1, wherein, along a thickness direction of the first electrode plate, a sum of a thickness of the protruding portion and a thickness of the first tab is less than or equal to a thickness of the first active material layer.

4. The electrode assembly according to claim 1, wherein the electrode assembly further comprises a separator, the separator is disposed on at least one side of the first electrode plate along a thickness direction of the first electrode plate, and the first portion is fixed and connected to the separator.

5. The electrode assembly according to claim 4, wherein the first portion comprises a hot-melt adhesive, and the first portion is bonded to the separator.

6. The electrode assembly according to claim 1, wherein an adhesive layer is disposed on one side of the protruding portion, the one side of the protruding portion is oriented toward the first tab, and the adhesive layer is bonded to the first tab.

7. The electrode assembly according to claim 1, wherein a first adhesive layer is disposed on one side of the protruding portion, the one side of the protruding portion is oriented toward the first portion, and the first adhesive layer is bonded to the first portion; and/or
a second adhesive layer is disposed on one side of the first portion, the one side of the first portion is oriented toward the protruding portion, and the second adhesive layer is bonded to the protruding portion.

8. The electrode assembly according to claim 1, wherein the first electrode plate is a positive electrode plate.

9. The electrode assembly according to claim 1, wherein the electrode assembly further comprises a second insulation piece, the second insulation piece is disposed on a surface of the first active material layer, and the second insulation piece is spaced apart from the first groove along a length direction of the first electrode plate.

10. The electrode assembly according to claim 1, wherein, along a length direction of the first electrode plate, a difference between a width of the first portion and a width of the first groove is 1 mm to 4 mm.

11. The electrode assembly according to claim 1, wherein, along a length direction of the first electrode plate, a difference between a width of the first groove and a width of the protruding portion is 0 mm to 4 mm.

12. The electrode assembly according to claim 1, wherein, along a length direction of the first electrode plate, a difference between a width of the protruding portion and a width of the first tab is 0 mm to 5 mm.

13. The electrode assembly according to claim 1, wherein the first active material layer is further disposed on another surface of the first current collector; the surface of the first current collector and the other surface of the first current collector being on two opposite sides of the first current collector, a second groove is created on the first active material layer on the other surface of the first current collector, the second groove is positioned on the other surface of the first current collector corresponding to a position of the first groove on the surface of the first current collector; and
the electrode assembly further comprises a second insulation piece, wherein the first second piece comprises a portion covering the second groove.

14. The electrode assembly according to claim 1, wherein, along a width direction of the first electrode plate, a lateral edge of the protruding portion protrudes beyond a lateral edge of the first groove, and the first portion covers the first groove.

15. The electrode assembly according to claim 1, wherein, along a thickness direction of the first electrode plate, the electrode assembly satisfies: 2a+b≤c+80 μm, wherein a thickness of the protruding portion is a, a thickness of the first tab is b, and a thickness of the first electrode plate is c.

16. An electrochemical device, wherein the electrochemical device comprises a packaging shell and the electrode assembly according to claim 1, and the electrode assembly is disposed in the packaging shell.

17. The electrochemical device according to claim 16, wherein the electrode assembly further comprises a separator, the separator is disposed on at least one side of the first electrode plate along a thickness direction of the first electrode plate, and the first portion is fixed and connected to the separator.

18. The electrochemical device according to claim 16, wherein, along a length direction of the first electrode plate, a difference between a width of the first groove and a width of the protruding portion is 0 mm to 4 mm.

19. The electrochemical device according to claim 16, wherein, along a length direction of the first electrode plate, a difference between a width of the protruding portion and a width of the first tab is 0 mm to 5 mm.

20. An electronic device, wherein the electronic device comprises an electrical component and the electrochemical device according to claim 16, and the electrical component is electrically connected to the electrochemical device.
